(19) United States
(12) Patent Application Publication
(10) Pub. No.: US 2009/0026662 A1
(43) Pub. Date: Jan. 29, 2009

(54) HYBRID POLYMER ELECTROLYTE, A LITHIUM SECONDARY BATTERY COMPRISING THE HYBRID POLYMER ELECTROLYTE AND THEIR FABRICATION METHODS

(75) Inventors: Kyung Suk Yun, Seoul (KR); Byung Won Cho, Seoul (KR); Seong-Mu Jo, Seoul (KR); Wha Seop Lee, Seoul (KR); Won Il Cho, Seoul (KR); Kun You Park, Seoul (KR); Hyung Sun Kim, Seoul (KR); Un Seok Kim, Seoul (KR); Seok Ku Ko, Seoul (KR); Suk Won Chun, Seoul (KR); Sung Won Choi, Koyang-Si (KR)

Correspondence Address: DARBY & DARBY P.C., P.O. BOX 770, Church Street Station, New York, NY, 10008-0770, US

(73) Assignee: KOREA INSTITUTE OF SCIENCE AND TECHNOLOGY, Seoul (KR)

(21) Appl. No.: 12/180,509

(22) Filed: Jul. 25, 2008

Related U.S. Application Data
(62) Division of application No. 10/276,878, filed on May 22, 2003, now abandoned.

(51) Int. Cl. B29C 47/00

(52) U.S. Cl. 264/466

(57) ABSTRACT

The present invention provides a novel hybrid polymer electrolyte, a lithium secondary battery comprising the hybrid polymer electrolyte polymer and their fabrication methods. More particularly, the present invention provides the hybrid polymer electrolyte comprising superfine fibrous porous polymer matrix with particles having diameter of 1-3000 nm, polymers and lithium salt-dissolved organic electrolyte solutions incorporated into the porous polymer matrix. The hybrid polymer electrolyte has advantages of better adhesion with electrodes, good mechanical strength, better performance at low and high temperatures, better compatibility with organic electrolytes of a lithium secondary battery and it can be applied to the manufacture of lithium secondary batteries.

### TECHNICAL FIELD

The present invention relates to a hybrid polymer electrolyte, a lithium secondary battery using the same, and to the fabrication method thereof.

### BACKGROUND ART

Lithium secondary batteries are typified by a lithium ion battery and a lithium polymer battery. A lithium ion battery uses a polyethylene (hereinafter referred to as “PE”) or polypropylene (hereinafter referred to as “PP”) separator film besides an electrolyte. In the fabrication of the lithium ion battery, because it is difficult to fabricate the battery by laminating electrodes and separator films in a flat-plate shape, it is fabricated by rolling the electrodes and separator films, and then inserting the rolled electrodes and separator films into a cylindrical or rectangular casing (D. Linden, Handbook of Batteries, McGraw-Hill Inc., New York (1995)). The lithium ion battery was developed by SONY Company in Japan at first and has been widely used all over the world; however, it has problems such as instability of the battery, intricacy of its fabrication process, restriction on battery shape and limitation of capacity.

On the contrary, a lithium polymer battery uses a polymer electrolyte having two functions, as a separator film and as an electrolyte at the same time, and it is now being viewed with keen interest as a battery being able to solve all of the above problems. The lithium polymer battery has an advantage in view of productivity because the electrodes and a polymer electrolyte can be laminated in a flat-plate shape and its fabrication process is similar to a fabrication process of a polymer film.

A conventional polymer electrolyte is mainly prepared with polyethylene oxide (hereinafter referred to as “PEO”), but its ionic conductivity is merely 10⁻⁸ S/cm at room temperature, and accordingly it can not be used commonly.

Recently, a gel or hybrid type polymer electrolyte having an ionic conductivity above 10⁻³ S/cm at room temperature has been developed.

K. M. Abraham et al. and D. L. Chua et al. disclose a polymer electrolyte of a gel type polyacrylonitrile (hereinafter referred to as “PAN”) group in U.S. Pat. No. 5,219,679 and in U.S. Pat. No. 5,240,790 respectively. The gel type PAN group polymer electrolyte is prepared by injecting a solvent compound (hereinafter referred to as an “organic electrolyte solution”) prepared with a lithium salt and organic solvents, such as ethylene carbonate and propylene carbonate, etc., into a polymer matrix. It has the advantages in that the contact resistance is small in charging/discharging of a battery and desorption of the active materials rarely takes place because the adhesive force of the polymer electrolyte is good, and accordingly adhesion between a composite electrode and a metal substrate is well developed. However, such a polymer electrolyte has a disadvantage in that its mechanical stability, namely its strength, is low because the electrolyte is a little bit soft. Especially, such deficiency in strength may cause many problems in the fabrication of an electrode and battery.

A. S. Gozdz et al. discloses a polymer electrolyte of hybrid type polyvinylidenedifluoride (hereinafter referred to as “PVdF”) group in U.S. Pat. No. 5,460,904. The polymer electrolyte of the hybrid type PVdF group is prepared by fabricating a polymer matrix having a porosity not greater than submicron, and then injecting an organic electrolyte solution into these small pores. It has the advantages in that because its compatibility with the organic electrolyte solution is good, the organic electrolyte solution injected into the small pores is not leaked so as to be safe in use and the polymer matrix can be prepared in the atmosphere because the organic electrolyte solution is injected afterwards. However, it has the disadvantage that the fabrication process is intricate because when the polymer electrolyte is prepared, an extraction process of a plasticizer and an impregnation process of the organic electrolyte solution are required. In addition, it has a critical disadvantage in that a process for forming a thin layer by heating and an extraction process are required in fabrication of electrodes and batteries because the mechanical strength of the PVdF group electrolyte is good but its adhesive force is poor.

Recently, a polymer electrolyte of a polymethylmethacrylate (hereinafter referred to as “PMMA”) group was presented in Solid State Ionics, 66, 97, 105 (1993) by O. Bohnke and G. Frand, et al. The PMMA polymer electrolyte has the advantages that it has an ionic conductivity of 10⁻³ S/cm at room temperature and its adhesive force and compatibility with an organic electrolyte solution are good. However, its mechanical strength is very poor, and accordingly it is unsuitable for the lithium polymer battery.

In addition, a polymer electrolyte of a polyvinylchloride (hereinafter referred to as “PVC”) group, which has good mechanical strength and has an ionic conductivity of 10⁻³ S/cm at room temperature, was presented in J. Electrochem. Soc. 140, L96 (1993) by M. Alamgir and K. M. Abraham. However, it has problems in that a low-temperature characteristic is poor and a contact resistance is high.

Accordingly, development of a polymer electrolyte having better adhesion with electrodes, good mechanical strength, better low- and high-temperature characteristics, and better compatibility with an organic electrolyte solution for a lithium secondary battery, etc. has been required.

### SUMMARY OF THE INVENTION

It is an object of the present invention to provide a novel hybrid polymer electrolyte.

It is another object of the present invention to provide a hybrid polymer electrolyte and its fabrication method, having good adhesion with electrodes, good mechanical strength, good low- and high-temperature characteristics, and good compatibility with an organic electrolyte solution for a lithium secondary battery, etc.

It is yet another object of the present invention to provide a lithium secondary battery and its fabrication method, having advantages of a simple fabrication process, advantage in scaling-up of the battery size, and superiority in energy density, cycle characteristics, low- and high-temperature characteristics, high rate discharge characteristics and stability.

### BRIEF DESCRIPTION OF DRAWINGS

FIG. 1 is a microphotograph of the porous polymer matrix of the present invention taken with a transmission electronic microscope.

FIGS. 2a-2c are process flow diagrams illustrating fabrication processes of lithium secondary batteries according to the present invention.

FIG. 3 is a graph showing charge and discharge characteristics of the lithium secondary batteries of Examples 1-8 and Comparative Examples 1 and 2.

FIG. 4 is a graph showing low- and high-temperature characteristics of the lithium secondary batteries of Example 1 and Comparative Example 2.

FIG. 5 is a graph showing high-rate discharge characteristics of the lithium secondary batteries of Example 1 and Comparative Example 2.

### DETAILED DESCRIPTION OF THE INVENTION

The present invention relates to a hybrid polymer electrolyte comprising a porous polymer matrix consisting of superfine polymer fibers having a diameter of 1 nm ˜3000 nm and a polymer electrolyte incorporated into the porous polymer matrix. In particular, the present invention relates to a hybrid polymer electrolyte obtained by dissolving a polymer in an organic solvent, generating a porous polymer matrix in the form of superfine fibers having a diameter of 1 nm ˜3000 nm from the polymeric solution by electrospinning, and injecting a polymer electrolyte solution, in which a polymer, a plasticizer and an organic electrolyte solution are mixed and dissolved together, into the pores of the porous polymer matrix. Hereinafter, “hybrid polymer electrolyte” means a polymer electrolyte in which a polymer electrolyte is incorporated into a porous polymer matrix; “Polymer electrolyte solution” means a solution in which the polymer incorporated into the porous polymer matrix is dissolved in an organic electrolyte solution, and it may further comprise a plasticizer. And, “polymer electrolyte” refers totally to an organic electrolyte solution and a polymer incorporated into a porous polymer matrix.

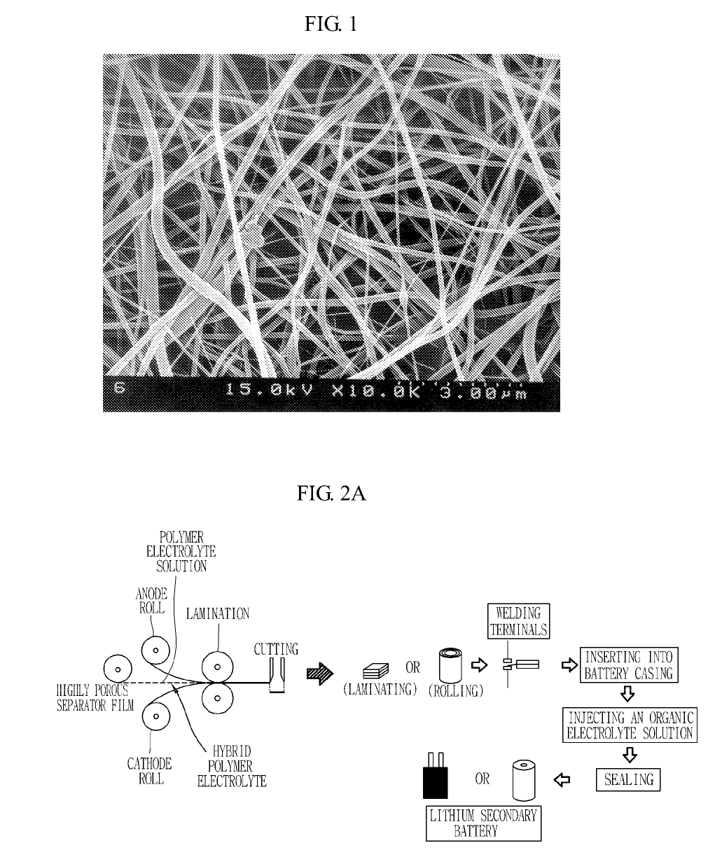

As depicted in FIG. 1, a porous polymer matrix consisting of superfine polymer fibers has a structure in which superfine fibers having a diameter of 1˜3000 nm are grouped disorderly and three-dimensionally. Due to the small diameter of the fibers, the ratio of surface area to volume and the void ratio are very, high compared to those of a conventional matrix. Accordingly, due to the high void ratio, the amount of electrolyte impregnated is large and the ionic conductivity is increased, and due to the large surface area, the contact area with the electrolyte can be increased and therefore the leakage of electrolyte can be minimized, in spite of the high void ratio. Furthermore, if a porous polymer matrix is fabricated by electrospinning, it has an advantage in that it can be prepared in the form of a film directly.

The polymers for forming the porous polymer matrix are not particularly limited, on condition that they can be formed into fibers; in particular, that they can be formed into superfine fibers by electrospinning. Examples include polyethylene, polypropylene, cellulose, cellulose acetate, cellulose acetate butylate, cellulose acetate propionate, polyvinylpyrrolidone-vinylacetate, poly[bis(2-(2-methoxyethoxyethoxy))phosphagene], polyethyleneimide, poly-ethyleneoxide, polyethylenesuccinate, polyethylenesulfide, poly(oxy-methylene-oligo-oxyethylene), polypropyleneoxide, polyvinylacetate, polyacrylonitrile, poly(acrylonitrile-co-methylacrylate), polymethyl methacrylate, poly(methylmethacrylate-co-ethylacrylate), polyvinylchloride, poly(vinylidene-chloride-co-acrylonitrile), polyvinylidenedifluoride, poly(vinylidenefluoride-co-hexafluoropropylene) or mixtures thereof.

Although there is no specific limitation on the thickness of the porous polymer matrix, it is preferable to have a thickness of 1 μm-100 μm. It is more preferable to have a thickness of 5 μm-70 μm and most preferable to have a thickness of 10 μm-50 μm. Furthermore, the diameter of the fibrous polymer in the polymer matrix is preferable to be adjusted to a range of 1˜3000 nm, more preferable to a range of 10 nm˜1000 nm, and most preferable to a range of 50 nm˜500 nm.

The polymers incorporated into the porous polymer matrix function as a polymer electrolyte, and examples include polyethylene, polypropylene, cellulose, cellulose acetate, cellulose acetate butylate, cellulose acetate propionate, polyvinylpyrrolidone-vinylacetate, poly[bis(2-(2-methoxyethoxy-ethoxy))phosphagene], polyethyleneimide, polyethyleneoxide, polyethylene-succinate, polyethylenesulfide, poly(oxymethylene-oligo-oxyethylene), polypropyleneoxide, polyvinylacetate, polyacrylonitrile, poly(acrylonitrile-co-methylacrylate), polymethylmethacrylate, poly(methylmethacrylate-co-ethylacrylate), polyvinylchloride, poly(vinylidenechloride-co-acrylonitrile), polyvinylidenedifluoride; poly(vinylidenefluoride-co-hexafluoropropylene), polyetylene glycol diacrylate, polyethylene glycol dimetha acrylate or mixtures thereof.

Although there is no specific limitation on the lithium salt incorporated into the porous polymer matrix, preferable example includes LiPF₆, LiCO₄₁, LiAsF₆, LiBF₄ and LiCF₃SO₃. It is more preferable to use LiPF₆.

Examples of the organic solvent used in the organic electrolyte solution can include ethylene carbonate, propylene carbonate, diethyl carbonate, dimethyl carbonate, ethylmethyl carbonate or mixtures thereof. In order to improve the low-temperature characteristic of the battery, methyl acetate, methyl propionate, ethyl acetate, ethyl propionate, butylene carbonate, γ-butyrolactone, 1,2-dimethoxyethane, 1,2-dimethoxyethane, dimethyl-acetamide, tetrahydrofuran or mixtures thereof can be further added to the organic solvent.

The hybrid polymer electrolyte of the present invention can further comprise a filling agent in order to improve porosity and mechanical strength. Examples of a filling agent include substances such as TiO₂, BaTiO₃, Li₂O, LiF, LiOH, Li₃N, BaO, Na₂O, MgO, Li₂CO₃, LiAlO₂, SiO₂, Al₂O₃, PTFE and mixtures thereof. Generally, the content of the filling agent is not greater than 20 wt % of the total hybrid polymer electrolyte.

The present invention also relates to a fabrication method for the hybrid polymer electrolyte. The method of the present invention comprises a step of obtaining a polymeric melt or solution, for forming a porous polymer matrix, by melting a polymer or dissolving a polymer in an organic solvent, a step of generating a porous polymer matrix with the obtained melt or solution and a step of injecting a polymer electrolyte solution into the obtained porous polymer matrix.

The step of obtaining a polymeric melt or solution is achieved by melting the polymer by heating or mixing the polymer with an appropriate organic solvent and then raising the temperature of the mixture to obtain a clear polymeric solution. If the polymer is dissolved in an organic solvent, the organic solvent which may be used is not particularly limited, on condition that it can dissolve polymers substantially and be applied to electrospinning. Solvents which might influence on the characteristics of battery can even be used, because the organic solvents are removed while fabricating the porous polymer matrix by electrospinning.

The fabrication of the porous polymer matrix of the present invention is generally achieved by electrospinning. In more detail, a porous polymer matrix can be fabricated by filling a polymeric melt or polymeric solution dissolved in an organic solvent, for forming the polymer matrix, into the barrel of an electrospinning apparatus, applying a high voltage to the nozzle, and discharging the polymeric melt or polymeric solution through the nozzle onto a metal substrate or a Mylar film at a constant rate. The thickness of the porous polymer matrix can be optionally adjusted by varying the discharging rate and time. As mentioned before, the preferable thickness range is within 1-100 μm. If the above-described method is used, a polymer matrix built up three-dimensionally with fibers having a diameter of 1˜3000 nm, not just the polymer fibers for forming a matrix, can be fabricated directly. In order to simplify the fabrication process, a porous polymer matrix can be generated onto electrodes directly. Accordingly, although the above-mentioned method is a fabrication in fibrous form, no additional apparatus is required and therefore an economical efficiency can be achieved by simplifying the fabrication process because the final product can be fabricated not just as fibers but as a film directly.

A porous polymer matrix using two or more polymers can be obtained by the following two methods: 1) After two or more polymers are melted or dissolved in one or more organic solvents, the obtained polymeric melts or solutions are filled into the barrel of an electrospinning apparatus, and then discharged using a nozzle to fabricate a porous polymer matrix in a state that polymer fibers are entangled with each other; and 2) After two or more polymers are melted separately or dissolved in organic solvents respectively in separate bowls, the obtained polymeric melts or solutions are filled into the different barrels of an electrospinning apparatus respectively, and then discharged using different nozzles to fabricate a porous polymer matrix in a state that the respective polymer fibers are entangled with each other respectively.

The hybrid polymer electrolyte can be obtained by injecting a polymer electrolyte solution into a porous polymer matrix fabricated by electrospinning. In more detail, it is obtained by dissolving a polymer in an organic electrolyte solution and/or a plasticizer to obtain a polymer electrolyte solution, and injecting the obtained polymer electrolyte solution into the porous polymer matrix by a die-casting.

It is preferable to use a plasticizer in the fabrication of the polymer electrolyte solution in order to improve properties of the polymer electrolyte solution. Examples of the plasticizer which may be used include propylene carbonate, butylene carbonate, 1,4-butyrolactone, diethyl carbonate, dimethyl carbonate, 1,2-dimethoxyethane, 1,3-dimethyl-2-imidazolidinone, dimethyl-sulfoxide, ethylene carbonate, ethylmethyl carbonate, N,N-dimethylformamide, N,N-dimethylacetamide, N-methyl-2-pyrrolidone, polyethylenesulforane, tetraethylene glycol dimethyl ether, acetone, alcohol and mixtures thereof. Because the plasticizers can be removed while fabricating the porous polymer matrix, there is no specific limitation on the kinds of plasticizer.

The preferable weight ratio of the polymer to the organic solvent is within a range of 1:1-1:20. The preferable weight ratio of the polymer to the plasticizer is within a range of 1:1-1:20.

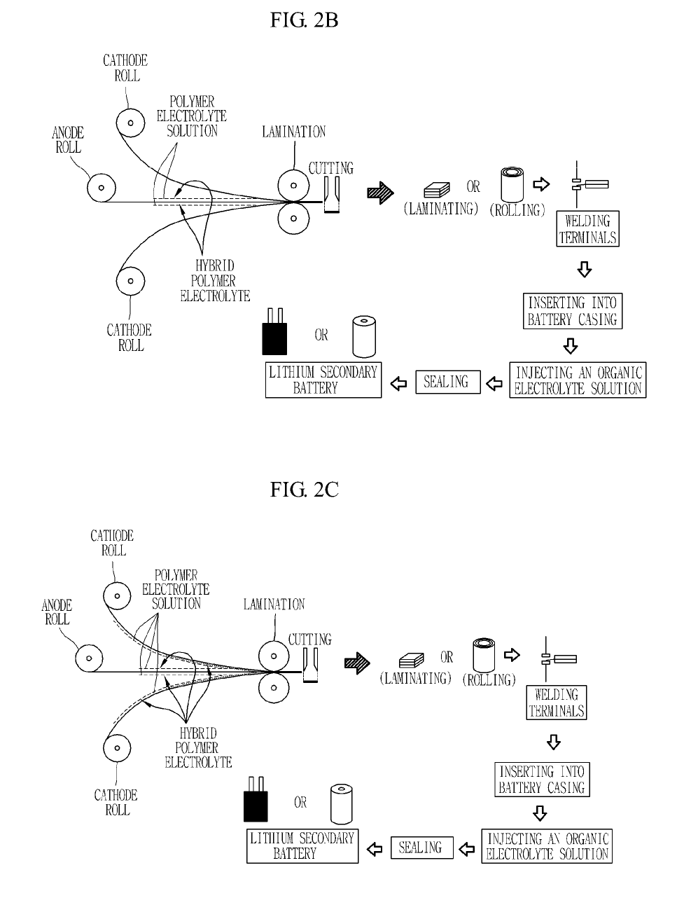

The present invention also relates to a lithium secondary battery comprising the above-described hybrid polymer electrolyte, and FIGS. 2a to 2c illustrate the fabrication processes of lithium secondary batteries of the present invention in detail. FIG. 2a illustrates a fabrication process of a battery, comprising inserting a hybrid polymer electrolyte, fabricated by incorporating a polymer electrolyte solution into a porous polymer matrix fabricated by electrospinning, between a cathode and an anode, making the electrolyte and electrodes into one body by a certain heat lamination process, inserting the resulting plate into a battery casing after laminating or rolling it, injecting an organic electrolyte solution into the battery casing, and then finally sealing the casing. FIG. 2b illustrates a fabrication process of a battery, comprising coating a hybrid polymer electrolyte onto both sides of a cathode or an anode, adhering an electrode having opposite polarity to the coated electrode onto the hybrid polymer electrolyte, making the electrolyte and electrodes into one body by a heat lamination process, inserting the resulting plate into a battery casing after laminating or rolling it, injecting an organic electrolyte solution into the battery casing, and then finally sealing the battery casing. FIG. 2c illustrates a fabrication process of a battery, comprising coating a hybrid polymer electrolyte onto both sides of one of two electrodes and onto one side of the other electrode, adhering the electrodes closely so as to face the hybrid polymer electrolytes to each other, making the electrolytes and electrodes into one body by a certain heat lamination process, inserting the resulting plate into a battery casing after laminating or rolling it, injecting an organic electrolyte solution into the battery casing, and sealing the battery casing.

As in a conventional lithium secondary battery, the anode and cathode of the present invention are prepared by mixing a certain amount of active materials, a conducting material, a bonding agent and organic solvents, casting the resulting mixture onto both sides of a copper or aluminum foil plate grid, and then dry-compressing the plate. The anode active material comprises one or more materials selected from the group consisting of graphite, cokes, hard carbon, tin oxide and lithiated compounds thereof. The cathode active material comprises one or more materials selected from the group consisting of LiClO₂, LiNiO₂, LiNiCoO₂, LiMn₂O₄, V₂O₅, and V₆O₁₃. And, metallic lithium or lithium alloys can be used as an anode of the present invention.

### EXAMPLES

The present invention will be described in more detail by way of the following examples, but those examples are given for the purpose to illustrate the present invention, not to limit the scope of it.

### Example 1

1-1) Fabrication of a Porous Polymer Matrix

20 g of polyvinylidenefluoride (Kynar 761) was added to 100 g of dimethylacetamide, and the resulting mixture was stirred at room temperature for 24 hours to give a clear polymeric solution. The resulting polymeric solution was filled into the barrel of an electrospinning apparatus and discharged onto a metal plate at a constant rate using a nozzle charged with 9 kV, to fabricate a porous polymer matrix film having a thickness of 50 μm.

1-2) Fabrication of a Hybrid Polymer Electrolyte

0.5 g of PAN (prepared by Polyscience Company, molecular weight of about 150,000), 2 g of PVdF (Atochem Kynar 761) and 0.5 g of PMMA (prepared by Polyscience Company) were added to a mixture of 15 g of 1M LiPF₆ solution in EC-DMC and 1 g of DMA solution (as a plasticizer), and the resulting mixture was blended for 12 hours. After blending, the resulting mixture was heated at 130° C. for one hour to give a clear polymer electrolyte solution. When a viscosity of several thousands cps suitable for casting was obtained, the resulting polymer electrolyte solution was cast into the porous polymer matrix fabricated in Example 1-1 by die-casting, to fabricate a hybrid polymer electrolyte in which the polymer electrolyte solution was incorporated into the porous polymer matrix.

1-3) Fabrication of a Lithium Secondary Battery

The hybrid polymer electrolyte fabricated in Example 1-2 was inserted between a graphite anode and a LiCoO₂ cathode. The resulting plates were cut so as to be 3 cm×4 cm in size and laminated. Terminals were welded on to the electrodes and the laminated plate was inserted into a vacuum casing. A 1M LiPF₆ solution in EC-DMC was injected into the vacuum casing, and then finally the vacuum casing was vacuum-sealed to fabricate a lithium secondary battery.

### Example 2

2-1) 20 g of polyvinylidenefluoride (Kynar 761) was added to 100 g of dimethylacetamide, and the resulting mixture was stirred at room temperature for 24 hours to give a clear polymeric solution. The resulting polymeric solution was filled into the barrel of an electrospinning apparatus and discharged onto both sides of a graphite anode at a constant rate using a nozzle charged with 9 kV, to fabricate a graphite anode coated with a porous polymer matrix film having a thickness of 50 μm.

2-2) 0.5 g of PAN (prepared by Polyscience Company, molecular weight of about 150,000), 2 g of PVdF (Atochem Kynar 761) and 0.5 g of PMMA (prepared by Polyscience Company) were added to a mixture of 15 g of 1M LiPF₆ solution in EC-DMC and 1 g of DMA solution (as a plasticizer). The resulting mixture was blended for 12 hours and then heated at 130° C. for one hour to give a clear polymer electrolyte solution. When a viscosity of several thousands cps suitable for casting was obtained, the resulting polymer electrolyte solution was cast into the porous polymer matrix obtained in Example 2-1 by die-casting, to generate a hybrid polymer electrolyte on both sides of the graphite anode.

2-3) A LiCoO₂ cathode was adhered onto the hybrid polymer electrolyte obtained in Example 2-2. The resulting plate was cut so as to be 3 cm×4 cm in size and laminated. Terminals were welded, on to the electrodes and the laminated plate was inserted into a vacuum casing. A 1M LiPF₆ solution in EC-DMC was injected into the vacuum casing, and the casing was then finally vacuum-sealed to fabricate a lithium secondary battery.

### Example 3

3-1) 20 g of polyvinylidenefluoride (Kynar 761) was added to 100 g of dimethylacetamide, and the mixture was stirred at room temperature for 24 hours to give a clear polymeric solution. The resulting polymeric solution was filled into the barrel of an electrospinning apparatus and discharged onto one side of a LiCoO₂ cathode at a constant rate using a nozzle charged with 9 kV, to fabricate a LiCoO₂ cathode coated with a porous polymer matrix film having a thickness of 50 μm on one side of it.

3-2) 0.5 g of PAN (prepared by Polyscience Company, molecular weight of about 150,000), 2 g of PVdF (Atochem Kynar 761) and 0.5 g of PMMA (prepared by Polyscience Company) were added to a mixture of 15 g of 1M LiPF₆ solution in EC-DMC and 1 g of DMA solution (as a plasticizer). The resulting mixture was blended for 12 hours and then heated at 130° C. for one hour to give a clear polymer electrolyte solution. When a viscosity of several thousands cps suitable for casting was obtained, the resulting polymer electrolyte solution was cast into the porous polymer matrix obtained in Example 3-1 by die-casting, to generate a hybrid polymer electrolyte on one side of the LiCoO₂ cathode.

3-3) The LiCoO₂ cathode obtained in Example 3-2 was adhered onto both sides of the graphite anode obtained in Example 2-2 so as to face the hybrid polymer electrolytes to each other. The resulting plate was made into one body by heat lamination at 110° C., followed by cutting so as to be 3 cm×4 cm in size and then laminated. Terminals were welded on to the electrodes and then the laminated plate was inserted into a vacuum casing. A 1M LiPF₆ solution in EC-DMC was injected into the casing, and the casing was then finally vacuum-sealed to fabricate a lithium secondary battery.

### Example 4

4-1) 10 g of polyvinylidenefluoride (Kynar 761) and 10 g of PAN (prepared by Polyscience Company, molecular weight of about 150,000) were added to 100 g of dimethylacetamide, and the resulting mixture was stirred at room temperature for 24 hours to give a clear polymeric solution. The resulting polymeric solution was filled into the barrel of an electros pinning apparatus and discharged onto both sides of a graphite anode using a nozzle charged with 9 kV at a constant rate, to fabricate a graphite anode coated with a porous polymer matrix film of 50 μm thickness.

4-2) 0.5 g of PAN (prepared by Polyscience Company, molecular weight of about 150,000), 2 g of PVdF (Atochem Kynar 761) and 0.5 g of PMMA (prepared by Polyscience Company) were added to a mixture of 15 g of 1M LiPF₆ solution in EC-DMC and 1 g of DMA solution (as a plasticizer). The resulting mixture was blended for 12 hours and then heated at 130° C. for one hour to give a clear polymer electrolyte solution. When a viscosity of several thousands cps suitable for casting was obtained, the resulting polymer electrolyte solution was cast into the porous polymer matrix obtained in Example 4-1 by die-casting, to generate a hybrid polymer electrolyte on both sides of the graphite anode.

4-3) The processes in Examples 4-1 and 4-2 were applied to one side of a LiCoO₂ cathode, instead of to both sides of a graphite anode, to fabricate a LiCoO₂ cathode coated with a hybrid polymer electrolyte on one side of it.

4-4) The LiCoO₂ cathode obtained in Example 4-3 was adhered onto both sides of the graphite anode obtained in Example 4-2 so as to face the hybrid polymer electrolytes to each other. The resulting plate was made into one body by heat lamination at 110° C., followed by cutting so as to be 3 cm×4 cm in size and then laminated. Terminals were welded on to the electrodes and then the laminated plate was inserted into a vacuum casing. A 1M LiPF₆ solution in EC-DMC was injected into the casing, and the casing was then finally vacuum-sealed to fabricate a lithium secondary battery.

### Example 5

5-1) Two polymeric solutions of 20 g of polyvinylidenefluoride (Kynar 761) in 100 g of dimethylacetamide and 20 g of PAN (prepared by Polyscience Company, molecular weight of about 150,000) in 100 g of dimethylacetamide were respectively filled into the different barrels of an electrospinning apparatus. And then, the solutions were discharged onto both sides of a graphite anode using nozzles charged with 9 kV respectively at a constant rate, to fabricate a graphite anode coated with a porous polymer matrix film having a thickness of 50 μm.

5-2) 0.5 g of PAN (prepared by Polyscience Company, molecular weight of about 150,000), 2 g of PVdF (Atochem Kynar 761) and 0.5 g of PMMA (prepared by Polyscience Company) were added to a mixture of 15 g of 1M LiPF₆ solution in EC-DMC and 1 g of DMA solution (as a plasticizer). The resulting mixture was blended for 12 hours and then heated at 130° C. for one hour to give a clear polymer electrolyte solution. When a viscosity of several thousands cps suitable for casting was obtained, the resulting polymer electrolyte solution was cast into the porous polymer matrix obtained in Example 5-1 by die-casting, to generate a hybrid polymer electrolyte on both sides of the graphite anode.

5-3) The processes in Examples 5-1 and 5-2 were applied to one side of a LiCoO₂ cathode, instead of to both sides of a graphite anode, to fabricate a LiCoO₂ cathode coated with a hybrid polymer electrolyte on one side of it.

5-4) The LiCoO₂ cathode obtained in Example 5-3 was adhered onto both sides of the graphite anode obtained in Example 5-2 so as to face the hybrid polymer electrolytes to each other. The resulting plate was made into one body by heat lamination at 110° C., followed by cutting so as to be 3 cm×4 cm in size and then laminated. Terminals were welded on to the electrodes and then the laminated plate was inserted into a vacuum casing. A 1M LiPF₆ solution in EC-DMC was injected into the casing, and the casing was then finally vacuum-sealed to fabricate a lithium secondary battery.

### Example 6

6-1) 20 g of polyvinylidenefluoride (Kynar 761) was added to 100 g of dimethylacetamide, and the mixture was stirred at room temperature for 24 hours to give a clear polymeric solution. The resulting polymeric solution was filled into the barrel of an electrospinning apparatus and discharged onto a metal plate at a constant rate using a nozzle charged with 9 kV, to fabricate a porous polymer matrix film having a thickness of 50 μm.

6-2) 2 g of oligomer of polyethylene glycol diacrylate (hereinafter referred to as “PEGDA”, prepared by Aldrich Company, molecular weight of 742) and 3 g of PVdF (Atochem Kynar 761) were added to 20 g of 1M LiPF₆ solution in EC-EMC. The resulting mixture was blended enough to be homogeneous at room temperature for 3 hours and then coated onto the porous polymer matrix obtained in Example 6-1. And then, an ultraviolet lamp having a power of 100 W was irradiated onto the porous polymer matrix for about 1.5 hours to induce a polymerization of the oligomer, to fabricate a hybrid polymer electrolyte in which the polymer electrolyte solution was incorporated into the porous polymer matrix.

6-3) Fabrication of a Lithium Secondary Battery

The hybrid polymer electrolyte fabricated in Example 6-2 was inserted between a graphite anode and a LiCoO₂ cathode, and the resulting plates were cut so as to be 3 cm×4 cm in size and laminated. Terminals were welded on to the electrodes and the laminated plate was inserted into a vacuum casing. A 1M LiPF₆ solution in EC-DMC was injected into the vacuum casing, and then finally the vacuum casing was vacuum-sealed to fabricate a lithium secondary battery.

### Example 7

7-1) 20 g of polyvinylidenefluoride (Kynar 761) was added to 100 g of dimethylacetamide, and the resulting mixture was stirred at room temperature for 24 hours to give a clear polymeric solution. The resulting polymeric solution was filled into the barrel of an electrospinning apparatus and discharged onto both sides of a graphite anode at a constant rate using a nozzle charged with 9 kV, to fabricate a graphite anode coated with a porous polymer matrix film having a thickness of 50 μm.

7-2) 2 g of oligomer of PEGDA (prepared by Aldrich Company, molecular weight of 742) and 3 g of PVdF (Atochem Kynar 761) were added to 20 g of 1M LiPF₆ solution in EC-EMC, and the resulting mixture was blended enough to be homogenous at room temperature for 3 hours. After blending, the resulting mixture was coated onto the porous polymer matrix obtained in Example 6-1. And then, an ultraviolet lamp having a power of 100 W was irradiated onto the porous polymer matrix for about 1.5 hours to induce a polymerization of the oligomer, to generate a hybrid polymer electrolyte on to both sides of the graphite anode.

7-3) A LiCoO₂ cathode was adhered onto the hybrid polymer electrolyte obtained in Example 7-2. The resulting plate was cut so as to be 3 cm×4 cm in size and laminated. Terminals were welded on to the electrodes and the laminated plate was inserted into a vacuum casing. A 1M LiPF₆ solution in EC-DMC was injected into the vacuum casing, and the casing was then finally vacuum-sealed to fabricate a lithium secondary battery.

### Example 8

8-1) Two polymeric solutions of 20 g of polyvinylidenefluoride (Kynar 761) in 100 g of dimethylacetamide and 20 g of PAN (prepared by Polyscience Company, molecular weight of about 150,000) In 100 g of dimethylacetamide were respectively filled into the different barrels of an electrospinning apparatus. And then, the respective solutions were discharged onto both sides of a graphite anode using nozzles charged with 9 kV respectively at a constant rate, to fabricate a graphite anode coated with a porous polymer matrix film having a thickness of 50 μm.

8-2) 2 g of oligomer of PEGDA (prepared by Aldrich Company, molecular weight of 742) and 3 g of PVdF (Atochem Kynar 761) were added to 20 g of 1M LiPF₆ solution in EC-EMC, and the resulting mixture was blended enough to be homogenous at room temperature for 3 hours. After blending, the resulting mixture was coated onto the porous polymer matrix obtained in Example 6-1. And then, an ultraviolet lamp having a power of 100 W was irradiated onto the porous polymer matrix for about 1.5 hours to induce a polymerization of the oligomer, to fabricate a hybrid polymer electrolyte on both sides of the graphite anode.

8-3) The processes of Example 8-1 and 8-2 were applied to one side of a LiCoO₂ cathode, instead of to both sides of a graphite anode, to fabricate a LiCoO₂ cathode coated with a hybrid polymer electrolyte on one side of it.

8-4) The LiCoO₂ cathode obtained in Example 8-3 was adhered onto both sides of the graphite anode obtained in Example 8-2 so as to face the hybrid polymer electrolytes to each other. The resulting plate was made into one body by heat lamination at 110° C., followed by cutting so as to be 3 cm×4 cm in size and then laminated. Terminals were welded on to the electrodes and then the laminated plate was inserted into a vacuum casing. A 1M LiPF₆ solution in EC-DMC was injected into the casing, and the casing was then finally vacuum-sealed to fabricate a lithium secondary battery.

### Comparative Examples

### Comparative example 1

A lithium secondary battery was fabricated by laminating electrodes and separator films in order of an anode, a PE separator film, a cathode, a PE separator film and an anode, inserting the resulting laminated plates into a vacuum casing, injecting a 1M LiPF₆ solution in EC-DMC into the casing, and then finally vacuum-sealing the casing.

### Comparative Example 2

According to the conventional fabrication method of a gel-polymer electrolyte, 9 g of 1M LiPF₆ solution in EC-PC was added to 3 g of PAN. The resulting mixture was blended for 12 hours and then heated at 130° C. for 1 hour to give a clear polymeric solution. When a viscosity of 10,000 cps suitable for casting was obtained, the polymeric solution was cast by die-casting to give a polymer electrolyte film. A lithium secondary battery was fabricated by laminating, in order, a graphite anode, an electrolyte, a LiCoO₂ cathode, an electrolyte and a graphite anode, welding terminals on to the electrodes, inserting the resulting laminated plates into a vacuum casing, injecting a 1M LiPF₆ solution in EC-DMC into the casing, and then finally vacuum-sealing the casing.

### Example 9

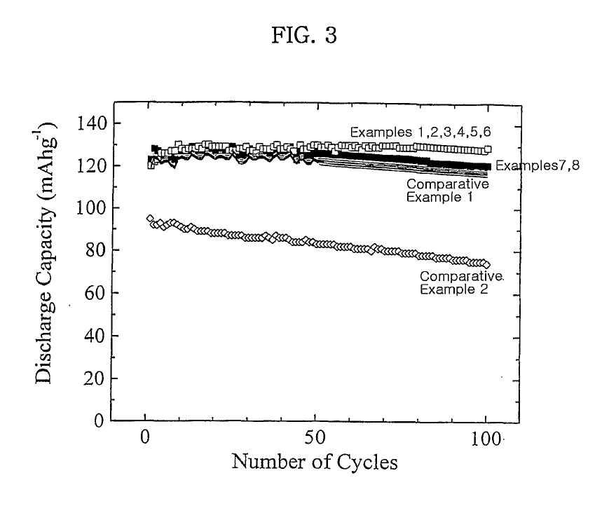

Charge/discharge characteristics of the lithium secondary batteries obtained in Examples 1-8 and Comparative Examples 1 and 2 were tested, and FIG. 3 shows the results. The tests for obtaining the charge/discharge characteristics were performed by a charge/discharge method of, after charging the batteries with a C/2 constant current and 4.2V constant voltage, discharging with a C/2 constant current, and the electrode-capacities and cycle life based on the cathode were tested. FIG. 3 shows that the electrode capacities and cycle life of the lithium secondary batteries of Examples 1-8 were improved compared to the lithium secondary batteries of Comparative Examples 1 and 2.

### Example 10

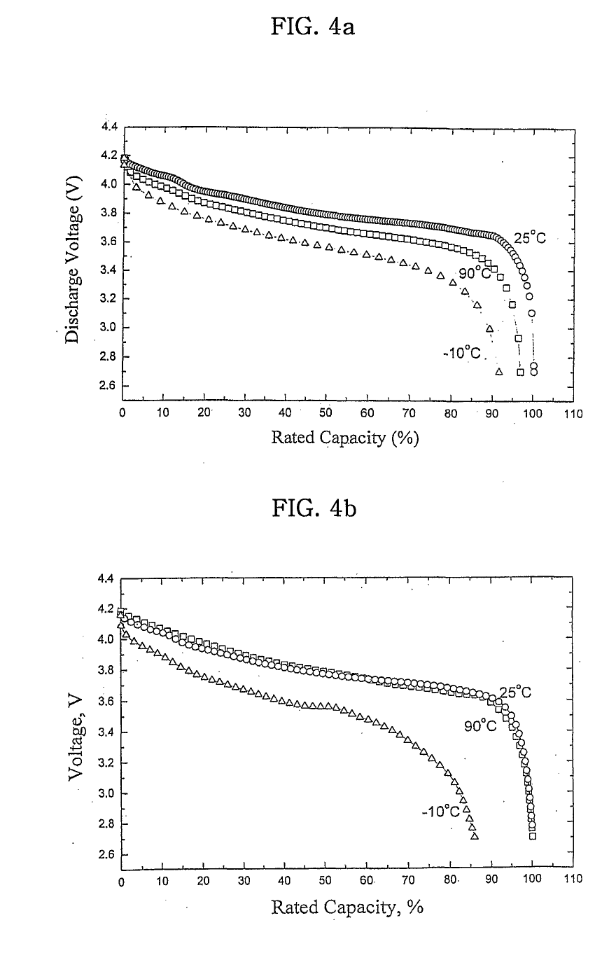

Low- and high-temperature characteristics of the lithium secondary batteries of Example 1 and Comparative Example 2 were tested, and FIGS. 4a and 4b illustrate the results (wherein FIG. 4a is for Example 1 and FIG. 4b is for Comparative Example 2). The tests for obtaining the low- and high-temperature characteristics of the lithium secondary batteries were performed by a charge/discharge method of charging the lithium batteries with a C/2 constant current and 4.2 V constant voltage, and then discharging with a C/5 constant current, FIGS. 4a and 4b show that the low- and high-temperature characteristics of the lithium secondary battery of Example 1 are better than those of the battery of Comparative Example 2. In particular, it shows that the battery of Example 1 has an outstanding characteristic of 91% even at −10° C.

### Example 11

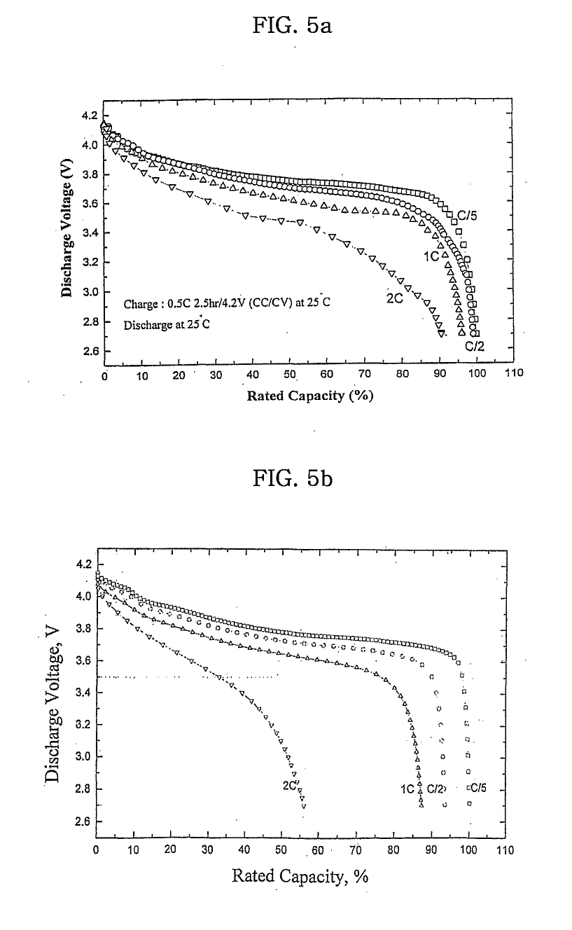

High rate discharge characteristics of the lithium secondary batteries of Example 1 and Comparative Example 2 were tested, and FIGS. 5a and 5b illustrate the results (wherein FIG. 5a is for Example 1 and FIG. 5b is for Comparative Example 2). The tests for obtaining the high rate discharge characteristics of the lithium secondary batteries were performed by a charge/discharge method of charging the lithium batteries with a C/2 constant current and 4.2 V constant voltage and then discharging while changing the constant current into C/5, C/2, 1C and 2C. As depicted in FIGS. 5a and 5b, the lithium secondary battery of Example 1 exhibited capacities such as 99% at C/2 discharge, 96% at 1C discharge and 90% at 2C discharge, based on the value of C/5 discharge. However, the lithium secondary battery of Comparative Example 2 exhibited low capacities such as 87% at 1C discharge and 56% at 2C discharge, based on the value of C/5 discharge. Accordingly, it was discovered that the high rate discharge characteristic of the lithium secondary battery of Example 1 was better than that of the lithium secondary battery of Comparative Example 2.

1-24. (canceled)

25. A fabrication method of a hybrid polymer electrolyte, comprising:
obtaining a polymeric solution by dissolving a first polymer in an organic solvent, the first polymer being able to be formed into polymer fibers;
generating a porous polymer matrix comprising the polymer fibers entangled with each other by filling the polymeric solution into an electrospinning apparatus and discharging the polymeric solution onto a substrate comprising a metal plate, a Mylar film and electrodes through a nozzle charged with a high voltage; and
injecting a polymer-electrolyte solution comprising a second polymer and an organic electrolyte solution, wherein a lithium salt is dissolved in an organic solvent, into the porous polymer matrix to incorporate the polymer-electrolyte solution into the porous polymer matrix.

26. The fabrication method of a hybrid polymer electrolyte according to claim 25, wherein a feature of the porous polymer matrix has a dimension of 1 nm˜3000 nm.

27. The fabrication method of a hybrid polymer electrolyte according to claim 25, wherein the first polymer is selected from the group consisting of polyethylene, polypropylene, cellulose, cellulose acetate, cellulose acetate butylate, cellulose acetate propionate, polyvinylpyrrolidone-vinylacetate, poly[bis(2-(2-methoxyethoxyethoxy))phosphagene], polyethyleneimide, polyethyleneoxide, polyethylenesuccinate, polyethylenesulfide, poly(oxymethylene-oligo-oxyethylene), polypropyleneoxide, polyvinyl acetate, polyacrylonitrile, poly(acrylonitrile-co-methylacrylate), polymethylmethacrylate, poly(methylmethacrylate-co-ethylacrylate), polyvinylchloride, poly(vinylidenechloride-co-acrylonitrile), polyvinylidenedifluoride, poly(vinylidenefluoride-co-hexafluoropropylene) and mixtures thereof.

28. The fabrication method of a hybrid polymer electrolyte according to claim 25, wherein the second polymer is selected from the group consisting of polyethylene, polypropylene, cellulose, cellulose acetate, cellulose acetate butylate, cellulose acetate propionate, polyvinylpyrrolidonevinylacetate, poly[bis(2-(2-methoxyethoxyethoxy))phosphagene], polyethyleneimide, polyethyleneoxide, polyethylenesuccinate, polyethylenesulfide, poly(oxymethylene-oligo-oxyethylene), polypropyleneoxide, polyvinyl acetate, polyacrylonitrile, poly(acrylonitrile-co-methylacrylate), polymethylmethacrylate, poly(methylmethacrylate-co-ethylacrylate), polyvinylchloride, poly(vinylidenechloride-co-acrylonitrile), polyvinylidenedifluoride, poly(vinylidenefluoride-co-hexafluoropropylene), polyetylene glycol diacrylate, polyethylene glycol dimetha acrylate or mixtures thereof.

29. The fabrication method of a hybrid polymer electrolyte according to claim 25, wherein the lithium salt comprises LiPF₆, LiClO₄, LiAsF₆, LiBF₄, LiCF₃SO₃ or mixtures thereof.

30. The fabrication method of a hybrid polymer electrolyte according to claim 25, wherein the organic solvent comprises ethylene carbonate, propylene carbonate, diethyl carbonate, dimethyl carbonate, ethylmethyl carbonate or mixtures thereof.

31. The fabrication method of a hybrid polymer electrolyte according to claim 30, wherein the organic solvent further comprises methyl acetate, methyl propionate, ethyl acetate, ethyl propionate, butylenecarbonate, γ-butyrolactone, 1,2-dimethoxyethane, dimethylacetamide, tetrahydrofuran or mixtures thereof.

32. The fabrication method of a hybrid polymer electrolyte according to claim 25, wherein the polymer-electrolyte solution further comprises a plasticizer.

33. The fabrication method of a hybrid polymer electrolyte according to claim 32, wherein the plasticizer is selected from the group consisting of propylene carbonate, butylene carbonate, 1,4-butyrolactone, diethyl carbonate, dimethyl carbonate, 1,2-dimethoxyethane, 1,3-dimethyl-2-imidazolidinone, dimethylsulfoxide, ethylene carbonate, ethylmethyl carbonate, N,N-dimethylformamide, N,N-dimethylacetamide, N-methyl-2-pyrrolidone, polyethylenesulforane, tetraethylene glycol dimethyl ether, acetone, alcohol and mixtures thereof.

34. The fabrication method of a hybrid polymer electrolyte according to claim 32, wherein the weight ratio of the second polymer to the plasticizer contained in the polymer-electrolyte solution is 1:1-1:20 and the weight ratio of the second polymer to the organic solvent is 1:1-1:20.

35. The fabrication method of a hybrid polymer electrolyte according to claim 32, wherein the polymer-electrolyte solution is prepared by stirring a mixture comprising the second polymer, the plasticizer and the organic electrolyte solution at 20° C.-150° C. for 30 minutes-24 hours.

36. The fabrication method of a hybrid polymer electrolyte according to claim 25, wherein the first polymer comprises a first polymeric mixture.

37. The fabrication method of a hybrid polymer electrolyte according to claim 25, wherein the second polymer comprises a second polymeric mixture.
